(19) United States
(12) Patent Application Publication
(10) Pub. No.: US 2011/0259959 A1
(43) Pub. Date: Oct. 27, 2011

(54) CHECKOUT CONTAINER AND CHECKOUT OPERATION THEREFOR

(76) Inventor: Jason Gene Knobloch, Austin, TX (US)

(21) Appl. No.: 13/091,445

(22) Filed: Apr. 21, 2011

Related U.S. Application Data
(60) Provisional application No. 61/326,641, filed on Apr. 21, 2010.

(51) Int. Cl. G06F 17/00; G06K 19/00

(52) U.S. Cl. 235/383; 235/487

(57) ABSTRACT

A container for sale as a bulk item container, wherein the container presented for sale includes at least one scannable code affixed thereto indicating the empty weight of the container. The container is received at a checkout counter, where the at least one code is scanned to register the empty weight of the container, which is communicated to a checkout register system. The container is weighed along with the product therein to determine a total weight of the container and product, which is also communicated to the checkout register system. The checkout register system automatically subtracts the empty weight of the container from the total weight of the container and product to determine a weight of the product contained in the container. The checkout register system receives a product code and computes a price responsive to the determined weight and a product price per weight indicated by the product code.

This application claims priority pursuant to 35 USC 119 to provisional U.S. Patent Application Ser. No. 61/326,641 entitled “Method, Apparatus and Computer Program Product for a Container Weight Checkout Tare Operation by Use of Scanning Bar Code on Container,” filed Apr. 21, 2010, which is hereby incorporated herein by reference.

### SUMMARY OF THE INVENTION

Methods, computer program products, and computer systems providing aspects of a checkout operation are described and claimed herein. In one implementation, a method for a checkout operation includes receiving a container at a checkout counter, wherein the container has a product therein that is sold by weight and wherein the container has at least one scannable code affixed thereto indicating an empty weight of the container. A scanning device scans the at least one code to register the empty weight of the container. The registered empty weight is communicated by the scanning device to a checkout register system. A scale local to the checkout counter weighs the container along with the product therein to determine a total weight of the container and product, and the total weight from the scale to the checkout register system is communicated. Circuitry of the checkout register system automatically subtracts the empty weight of the container, which is registered by the scanning of the at least one code, from the total weight of the container and product, which is determined by the weighing of the container along with the product therein, to determine a weight of the product contained in the container. The checkout register system receives a product code for the product, and circuitry of the checkout register system automatically computes a price for the product contained in the container responsive to i) the weight of the product, which is determined by the subtracting, and ii) a product price per unit of weight, which is indicated by the received product code.

In another aspect, the checkout register system receiving the product code for the product by the checkout register system includes receiving the product code from a keypad input device.

In another aspect, the at least one scannable code affixed to the container indicates the product code and the scanning of the at least one scannable code by the scanning device includes scanning the product code to register the product code, and wherein receiving the product code for the product by the checkout register system includes receiving the product code from the scanning device.

In another aspect, the automatic subtracting by circuitry of the checkout register system includes automatically subtracting by a microprocessor.

In another aspect, the automatic computing of the price by circuitry of the checkout register system includes automatically computing by a microprocessor.

In another aspect, the method includes presenting the container for sale as a bulk item container, wherein the container presented for sale includes at least one scannable code affixed thereto indicating the empty weight of the container.

In another aspect, the method includes presenting the container for sale as a bulk item container, wherein the container presented for sale includes at least one scannable code affixed thereto and the at least one scannable code indicates the empty weight of the container and the product code, so that the container is suitable for containing a pre-determined product of the indicated product code.

In another aspect, the method includes receiving the empty container on a scale remote from the checkout counter prior to receiving the container at the checkout counter. A user inputs the product code via a keypad associated with the remote scale, and the remote scale prints at least one scannable code indicating the weight of empty container for scanning at the checkout counter.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

Novel features of this disclosure are set forth in the appended claims. These features, as well as advantages and a preferred mode of use thereof, will best be understood by reference to the following Detailed Description of one or more illustrative embodiments of the invention, particularly when read in conjunction with the accompanying figures, which are briefly described as follows:

FIG. 1A illustrates a container with a lid, wherein the container has a preprinted code, according to one or more embodiments of the invention.

FIG. 1B illustrates a checkout counter and a remote device, according to one or more embodiments of the invention.

FIG. 2 is a flow chart illustrating aspects of a checkout operation and related operations.

FIG. 3 illustrates one example of a computer system in which one or more processes of FIG. 2 are implemented, according to an embodiment of the present invention.

### DETAILED DESCRIPTION

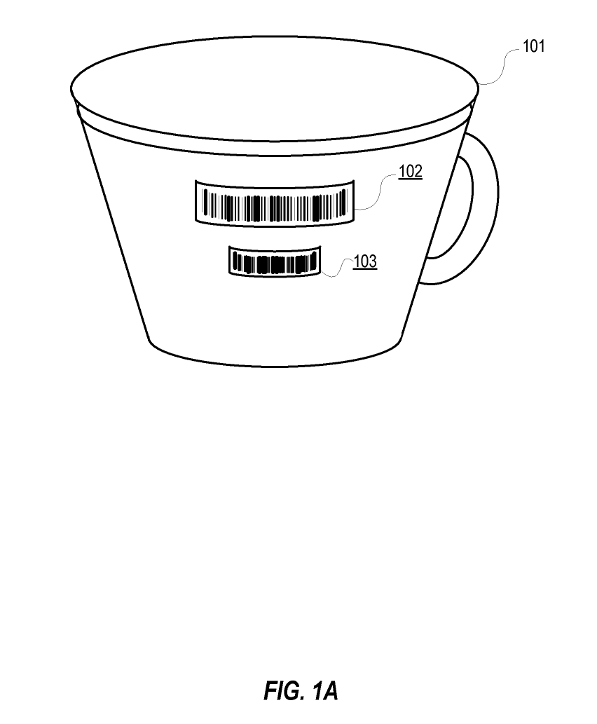

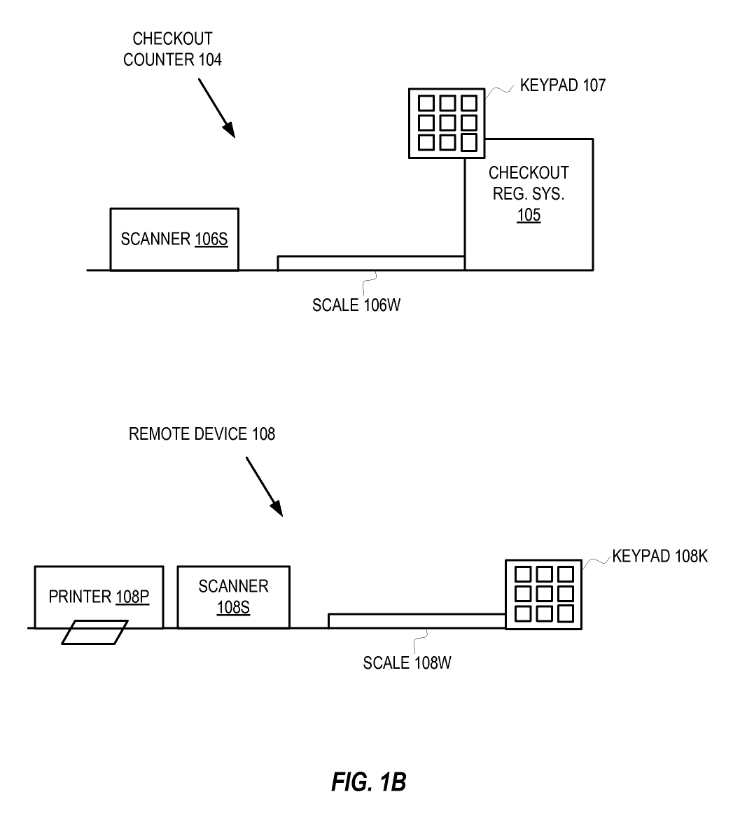

Referring to FIGS. 1A and 1B, a container 101 with a permanent, preprinted, scannable code 102 is shown, such as a bar code, according to an embodiment of the invention. For such a container 101, preprinted code 102 indicates the weight of the empty container 101. Container 101 may be sold as a bulk item container 101 at grocery and other stores. As such, container 101 may also include a sticker (which may be removable or permanent) with a preprinted code 103 that identifies container 101 as a saleable inventory item, itself, and that also indicates the price of empty container 101. The sale of container 101 itself per preprinted code 103 may be accomplished in a manner well known in the art and will not be further described herein.

In embodiments, it may be desired that container 101 will substantially always be filled with one particular type of bulk product, which is typically a dry good, such as, for example, sugar, grain, coffee, nuts, fruit, etc., but which may also be a non-dry good, such as, for example, cooking oil, peanut butter, prepared food, etc., may be for a dedicated type of goods. In this case, code 102 may also indicate the type of goods for which the container 101 will be dedicated, i.e., a product code. Alternatively, an additional sticker or printing may be affixed for indicating the product. This arrangement is advantageous because it does not require the user (cashier or customer) to know or lookup a code for the product filling the container.

The information items indicated by codes such as 102 and 103 are listed in a computer readable memory 104 accessible to a checkout register computer system 105. The owner of container 101 (the “customer”) may bring container 101 to the store and fill it with a product, such as a product sold in bulk, as previously mentioned. The customer may then take the full container 101 to a checkout counter 104 having a checkout register computer system 105. In a checkout operation, the user (a cashier or the customer) places container 101 on or near a scanner device 106S that communicates with checkout system 105. Scanner 106S scans code(s) 102, etc. and communicates information from code 102, which includes the empty weight of container 101, to checkout register system 105. (In an embodiment in which code 102 also indicates type of contents, scanner also detects this information from code 102 and communicates it to system 105.)

Likewise, a scale 106W that communicates with checkout system 105 is located near scanner 106S. Responsive to container 101 being placed on scale 106W, it automatically weighs the full container 101 and communicates the total measured weight of the full container 101 to checkout register system 105.

In response, checkout system 105 prompts the user to input a bulk product code (such as via a keypad 107 of system 105, or via scanning a code on a printed sheet of product codes, for example), where the bulk product code indicates the type of contents of container 101. (In an embodiment in which this product information is included in code 102, this information is instead communicated from scanner device 106S, as previously mentioned.) Checkout register system 105 subtracts the empty weight of container 101 from the total measured weight of the container 101 and product therein, to yield the weight of bulk product in container 101, computes the price for that calculated weight of bulk product, according to the price indicated by the bulk product code, and charges the customer for the calculated weight of bulk product, which does not include the weight of container 101.

Containers such as container 101 may be made of various materials to suit the needs of the market (glass, plastic, metal, etc.).

In yet another embodiment, a customer brings their own container 101 to the place of business, places the container on a scale of a device 108, which may be like aspects of device 106W, but does not necessarily communicate with checkout system 105 (although it may do so, in embodiments), and may be remote therefrom. The customer then enters a request via a keypad of device 108, requesting that device 108 produce a label for container 101 indicating the weight of container 101. Responsively, a printer of device 108 prints a label indicating the weight of the customer's empty container 101 for a later tare operation at checkout, which may include device 108 first looking up an empty-container-code from a memory accessible to device 108, e.g., accessible by a microprocessor of device 108 or other circuitry of device 108, in various embodiments. The customer may, in embodiments, also specify a dedicated type of product for container 101 and may request that the label include that code on the same label or on another label. The label (or labels) may have a sticky back, so that the customer may affix it to container 101. This arrangement allows customers to use their own containers and still achieve automatic tare operation without requiring customers to purchase containers having preprinted container weight codes.

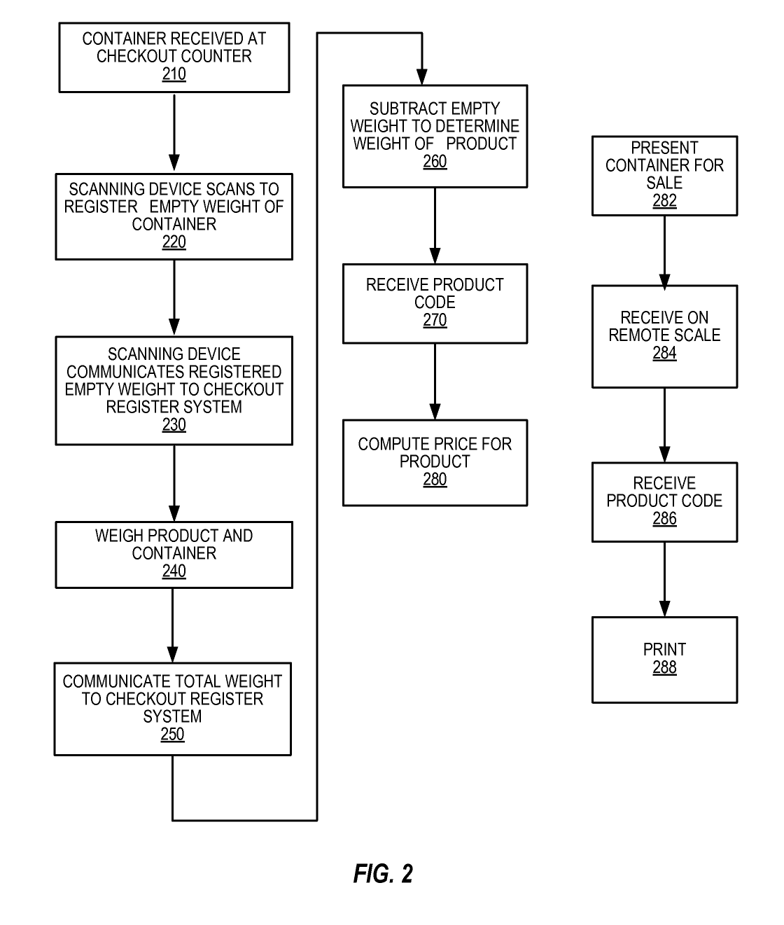

Referring to FIG. 2, a flow chart illustrates aspects of a checkout operation, according to one or more embodiments of the invention. At 210 a checkout counter receives a container holding a product that is sold by weight. The container has at least one scannable code affixed to it indicating the empty weight of the container.

At 220, the scanning device scans the at least one code to register the empty weight of the container. At 230, the scanning device communicates the registered empty weight to a checkout register system. At 240, a scale local to the checkout counter weighs the container along with the product therein to determine a total weight of the container and product. At 250, the scale communicates the total weight to the checkout register system. At 260, the circuitry of the checkout register system automatically subtracts the empty weight of the container, which is registered by the scanning of the at least one code, from the total weight of the container and product, which is determined by the weighing of the container along with the product therein, to determine a weight of the product contained in the container. In one or more embodiments, the subtracting includes automatically subtracting by a microprocessor.

At 270, the checkout register system receives a product code for the product. This may include receiving the product code from a local keypad input device. Alternatively, the at least one code indicates a product code, and scanning of the code by a scanning device registers the product code. Accordingly, the checkout register system receives the product code for the product from the scanning device.

At 280, the circuitry of the checkout register system automatically computes a price for the product contained in the container responsive to i) the weight of the product, which is determined by the subtracting, and ii) a product price per unit of weight, which is indicated by the received product code. In one or more embodiments, the computing of the price includes automatically computing by a microprocessor.

In embodiments of the invention, a container may be presented 282 for sale having at least one affixed scannable code indicating the empty weight of the container. Alternatively, the at least one affixed scannable code indicates both the empty weight of the container and the product code, so that the container is suitable as a dedicated purpose container, i.e., for containing a pre-determined product of the indicated product code. Also, the empty container may be received 284 on a scale remote from the checkout counter prior to receiving the container at the checkout counter. Further, the product code may be received 286 from user input via a keypad associated with the remote scale, and a printer associated with the remote scale may print 288 at least one scannable code indicating the weight of empty container for scanning at the checkout counter, which may then be affixed to the container.

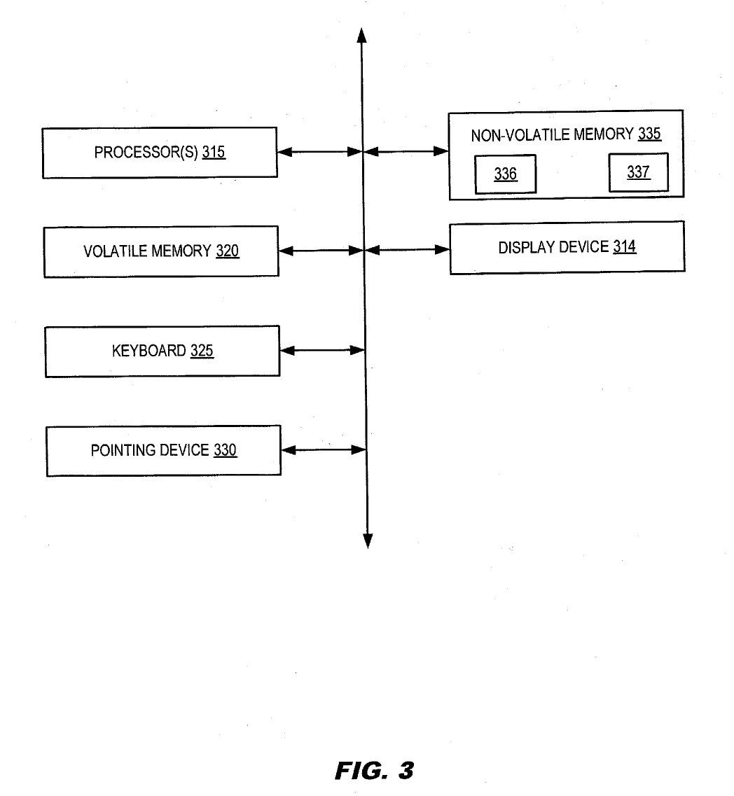

Referring now to FIG. 3, a computer system 310 is illustrated, which may take a variety of forms, including a personal computer system, mainframe computer system, workstation, server, etc. That is, it should be understood that the term “computer system” is intended to encompass any device having a processor that executes instructions from a memory medium. In the illustrated system embodiment, system 310 includes one or more processors 315, a keyboard 325, a pointing device 330, and tangible, computer-readable storage media, including volatile 320, and nonvolatile memory 335, e.g., ROM, hard disk, floppy disk, CD-ROM, and DVD, and display device 314.

Memory 335 of system 310 stores computer programs 336 (also known as “software programs”), wherein programs 336 include instructions that are executable by one or more processors 315 to implement various embodiments of a method in accordance with the present invention. Memory 335 of system 310 also has data 337 stored thereon that provides circuit structures, logical entity properties including physical locations, etc. Programs 336 may include instructions for implementing processes 700 such as those of FIG. 2, for example, as well as other processes describe herein.

Those of ordinary skill in the art will appreciate that the hardware in FIG. 3 may vary depending on the implementation. For example, other peripheral devices may be used in addition to or in place of the hardware depicted in FIG. 3. The depicted example is not meant to imply architectural limitations with respect to the present invention. Various embodiments of system 310 implement one or more software programs 336 and data 337 in various ways, including procedure-based techniques, component-based techniques, and/or object-oriented techniques, among others. Specific examples include XML, C, C++ objects, Java and commercial class libraries.

As will be appreciated by one skilled in the art, aspects of the present invention may be embodied as an apparatus, system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Furthermore, aspects of the present invention may take the form of a computer program product embodied in one or more computer readable medium(s) having computer readable program code embodied thereon. Any combination of one or more computer readable medium(s) may be utilized. In the context of this document, a computer readable storage medium may be any tangible medium that can store a program for use by, or in connection, with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a local computer, partly on the local computer, as a stand-alone software package, partly on the local computer and partly on a remote computer, or entirely on the remote computer, which may or may not be a server. In the latter scenario, the remote computer may be connected to the local computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be supplied to a processor of a general purpose computer, special purpose computer, or other programmable data processing apparatus, such that the processor and instructions provide a machine that implements functions and actions specified in the one or more flowchart or block diagram herein. The processor of a general purpose computer, special purpose computer, or other programmable data processing apparatus may be referred to herein as a “microprocessor.” However, the term “microprocessor” should not be interpreted as being limited to a single-chip processing unit, unless explicitly so stated.

These computer program instructions may also be stored in a computer readable medium that can direct a computer, other programmable data processing apparatus, or other devices to function in a particular manner, such that the instructions stored in the computer readable medium produce an article of manufacture including instructions which implement any function or action specified in the one or more flowchart or block diagram herein. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing any function or action specified in the one or more flowchart or block diagram herein.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Reference throughout this specification to “one embodiment,” “embodiments,” or similar language means that a particular feature, structure, or characteristic described in connection with the embodiments is included in at least one embodiment of the present invention. Thus, appearances of the phrases “in one embodiment,” “in an embodiment,” “embodiments,” and similar language throughout this specification may, but do not necessarily, all refer to the same embodiment. Furthermore, the described features, structures, aspects, and/or characteristics of the invention may be combined in any suitable manner in one or more embodiments. Correspondingly, even if features may be initially claimed as acting in certain combinations, one or more features from a claimed combination can in some cases be excised from the combination, and the claimed combination can be directed to a sub-combination or variation of a sub-combination.

In the descriptions herein, numerous specific details are provided, such as examples of programming, software modules, user selections, network transactions, database queries, database structures, hardware modules, hardware circuits, hardware chips, controllers, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations may be not shown or described in detail to avoid obscuring aspects of the invention.

As used herein, the terms “comprises,” “comprising,” or any other variation thereof, may be intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as essential or critical.

Benefits, advantages and solutions to problems have been described above with regard to specific embodiments. However, the benefits, advantages, solutions to problems, and any element(s) that may cause any benefit, advantage, or solution to occur or become more pronounced may be not to be construed as critical, required, or essential features or elements of any or all the claims.

Those skilled in the art having read this disclosure will recognize that changes and modifications may be made to the embodiments without departing from the scope of the present invention. It should be appreciated that the particular implementations shown and described herein may be illustrative of the invention and its best mode and may be not intended to otherwise limit the scope of the present invention in any way. Other variations may be within the scope of the following claims.

While this specification contains many specifics, these should not be construed as limitations on the scope of the invention or of what can be claimed, but rather as descriptions of features specific to particular implementations of the invention. Headings herein may be not intended to limit the invention, embodiments of the invention or other matter disclosed under the headings.

What is claimed is:

1. A method for a checkout operation comprising:
receiving a container at a checkout counter, wherein the container has a product therein that is sold by weight and wherein the container has at least one scannable code affixed thereto indicating an empty weight of the container;
scanning the at least one code by a scanning device to register the empty weight of the container;
communicating the registered empty weight by the scanning device to a checkout register system;
weighing the container along with the product therein by a scale local to the checkout counter, to determine a total weight of the container and product;
communicating the total weight from the scale to the checkout register system;
circuitry of the checkout register system automatically subtracting the empty weight of the container, which is registered by the scanning of the at least one code, from the total weight of the container and product, which is determined by the weighing of the container along with the product therein, to determine a weight of the product contained in the container;
receiving, by the checkout register system, a product code for the product; and
circuitry of the checkout register system automatically computing a price for the product contained in the container responsive to i) the weight of the product, which is determined by the subtracting, and ii) a product price per unit of weight, which is indicated by the received product code.

2. The method of claim 1, wherein receiving the product code for the product by the checkout register system includes receiving the product code from a keypad input device.

3. The method of claim 1, wherein the at least one scannable code affixed to the container indicates the product code and the scanning of the at least one scannable code by the scanning device includes:
scanning the product code to register the product code, and wherein receiving the product code for the product by the checkout register system includes receiving the product code from the scanning device.

4. The method of claim 1, wherein the automatic subtracting by circuitry of the checkout register system includes automatically subtracting by a microprocessor.

5. The method of claim 1, wherein the automatic computing of the price by circuitry of the checkout register system includes automatically computing by a microprocessor.

6. The method of claim 1, including:
presenting the container for sale as a bulk item container, wherein the container presented for sale includes at least one scannable code affixed thereto indicating the empty weight of the container.

7. The method of claim 1, including:
presenting the container for sale as a bulk item container, wherein the container presented for sale includes at least one scannable code affixed thereto and the at least one scannable code indicates the empty weight of the container and the product code, so that the container is suitable for containing a pre-determined product of the indicated product code.

8. The method of claim 1, wherein the method comprises:
receiving the empty container on a scale remote from the checkout counter prior to receiving the container at the checkout counter;
receiving the product code from user input via a keypad associated with the remote scale; and
printing, by the remote scale, at least one scannable code indicating the weight of empty container for scanning at the checkout counter.

9. A computer program product for a checkout operation, the computer program product including a computer readable storage medium having instructions stored thereon for execution by a computer, wherein the instructions, when executed by the computer, cause the computer to implement a method comprising the steps of:
receiving a container at a checkout counter, wherein the container has a product therein that is sold by weight and wherein the container has at least one scannable code affixed thereto indicating an empty weight of the container;
scanning the at least one code by a scanning device to register the empty weight of the container;
communicating the registered empty weight by the scanning device to a checkout register system;
weighing the container along with the product therein by a scale local to the checkout counter, to determine a total weight of the container and product;
communicating the total weight from the scale to the checkout register system;
circuitry of the checkout register system automatically subtracting the empty weight of the container, which is registered by the scanning of the at least one code, from the total weight of the container and product, which is determined by the weighing of the container along with the product therein, to determine a weight of the product contained in the container;
receiving, by the checkout register system, a product code for the product; and
circuitry of the checkout register system automatically computing a price for the product contained in the container responsive to i) the weight of the product, which is determined by the subtracting, and ii) a product price per unit of weight, which is indicated by the received product code.

10. The computer program product of 9, wherein receiving the product code for the product by the checkout register system includes receiving the product code from a keypad input device.

11. The computer program product of claim 9, wherein the at least one scannable code affixed to the container indicates the product code and the scanning of the at least one scannable code by the scanning device includes:
scanning the product code to register the product code, and wherein receiving the product code for the product by the checkout register system includes receiving the product code from the scanning device.

12. The computer program product of claim 9, wherein the automatic subtracting by circuitry of the checkout register system includes automatically subtracting by a microprocessor.

13. The computer program product of claim 9, wherein the automatic computing of the price by circuitry of the checkout register system includes automatically computing by a microprocessor.

14. The computer program product of claim 9, wherein the empty container is received on a scale remote from the checkout counter prior to receiving the container at the checkout counter and wherein the method implemented by the computer executing the instructions of the computer program product comprises:
receiving the product code from user input via a keypad associated with the remote scale; and
printing, by the remote scale, at least one scannable code indicating the weight of empty container for scanning at the checkout counter.

15. A container for sale as a bulk item container, wherein the container presented for sale includes at least one scannable code affixed thereto indicating the empty weight of the container.

16. The container of claim 15, wherein the at least one scannable code indicates the empty weight of the container and the product code, so that the container is suitable for containing a pre-determined product of the indicated product code.
